(19) United States
(12) Patent Application Publication
(10) Pub. No.: US 2004/0235545 A1
(43) Pub. Date: Nov. 25, 2004

(54) Method and system for playing interactive game

(76) Inventor: David Alan Landis, Midlothian, VA (US)

Correspondence Address: HUNTON & WILLIAMS, Riverfront Plaza, East Tower, 951 E. Byrd St., Richmond, VA, 23219-4074, US

(21) Appl. No.: 10/441,737

(22) Filed: May 20, 2003

(51) Int. Cl. A63F 13/00

(52) U.S. Cl. 463/9

(57) ABSTRACT

A method and system for playing an interactive game is disclosed. The game involves receiving directional audio cues from one of a plurality of speakers connected to a multi-channel sound source. A player responds to the directional audio cues by moving about a room, continuing to change location based on the directional audio cues. Additionally, a player acts out scenes corresponding to a simulated audio environment created by a surround sound effect through the use of the multi-channel sound source and the plurality of speakers. The game may also involve responding to instructional audio cues which tell a player to perform a certain act or assume a particular posture. The game may also involve visual cues which are synchronized with the different audio cues and which aid the player when the visual cues are displayed on a display device.

### BACKGROUND OF THE INVENTION

Children benefit greatly from stimulation which enhances mental and physical growth. However, studies repeatedly show that children increasingly spend much of their crucial early development years watching television. While television may be visually stimulating, television by itself does not provide other forms of stimulation beneficial to childhood development. In many instances, television may even retard mental and physical growth by replacing other forms of stimulation which encourages physical activity and social interaction.

Parents may sometimes assist providing alternative stimulation to that of television, such as by reading a book or playing a game with a child. However, particularly with young children, a parent may tire of playing the same game or reading the same story over and over as young children often request when engaging in an activity they enjoy.

It may be desirable to provide a game which stimulates the imagination of children in an interactive fashion. A game may also be desired which encourages physical activity and promotes social interaction. It may further be desired to provide a game which may be played independently by a child without extensive parental interaction or supervision.

### SUMMARY OF THE INVENTION

A method of play is disclosed which comprises receiving a first set of directional audio cues transmitted from a multi-channel sound source to at least one of a plurality of speakers positioned within a defined space, the directional audio cues directing a player to move from a first location to a second location within the defined space and responding to the first set of directional audio cues by moving from the first location to the second location within the defined space corresponding to the directional audio cues. The method also comprises receiving at least a second set of directional audio cues at the second location in the defined space and responding to at least the second set of directional audio cues by moving about the defined space from the second location to at least a third location corresponding to at least the second set of directional audio cues. The method of play further comprises acting out scenes which correspond to a surround-sound simulated environment created by the multi-channel sound source simultaneously emitting different complementary sounds from each of the plurality of speakers.

A system is also disclosed which comprises a multi-channel sound source, a plurality of speakers connected to receive audio signals from the multi-channel sound source, a video display source, a display device connected to receive video signals from a video display source, and a device containing audio data capable of distribution through the multi-channel sound source to the plurality of speakers and containing video data capable of distribution to the display device.

### BRIEF DESCRIPTION OF THE DRAWINGS

FIG. 1 is a view of one step of a method of play in accordance with an exemplary embodiment of the invention.

FIG. 2 is a view of a second step of a method of play in accordance with an exemplary embodiment of the invention.

FIG. 3 is a view of yet another step of a method of play in accordance with an exemplary embodiment of the invention.

FIG. 4 is a view of a visual cue in accordance with an exemplary embodiment of the invention.

FIG. 5 is another view of a visual cue in accordance with an exemplary embodiment of the invention.

### DETAILED DESCRIPTION OF EXEMPLARY EMBODIMENTS

The present invention is directed to a method and system of playing an interactive game. The game may be particularly suited to facilitate physical and mental stimulation in young children, such as toddlers. Generally, the method uses a multi-channel sound source, and a plurality of speakers, such as found in a surround sound system. A player receives directional audio cues which emanate from at least one of the plurality of speakers. In response to the directional audio cue, the player moves from a starting location to a second location. At the second location, a second set of directional audio cues is received by the player, and the player again moves to yet another location corresponding to the next set of directional audio cues. A player continues to move about the room as additional directional audio cues are received and responded to by the player.

The surround sound system also produces sounds which simulate an audio environment. The method of play further involves a player acting out scenes which correspond to the simulated environment.

As is well known, a surround sound speaker system is made up of multiple speakers that are typically positioned in different areas within a room. However, speakers may be positioned in any defined space and hence may also be positioned in a courtyard, play area, or the like for example. A surround sound system is a system made up of a series of stationary speakers positioned around a listener in specific locations and connected to a multi-channel sound system. A popular version of this arrangement is called 5.1 surround sound audio. The “5” represents five speakers that may be positioned around a person at particular locations. Typical locations for speaker placement are front center, front left, front right, rear left, and rear right, where front, rear, left, center, and right are defined from the point of view of a person in the room facing an arbitrary reference point. The “0.1” refers to a sub-woofer that creates deep bass tones from any placement in the room and which may complement or contrast the five other speakers, which may have a higher frequency.

Although the exemplary embodiments described herein refer to a 5.1 surround sound system, the invention is not limited to a 5.1 surround sound system. As one skilled in the art will appreciate, other surround systems may be used. Likewise, although the exemplary embodiments refer to a DVD as the device on which audio and video data is stored and accessed, any device for storing audio and video data which may be accessed and distributed to a surround sound system and a video display device could also be used within the scope of this invention. As surround sound data is also capable of being broadcast, such as via satellite or cable, the audio and video data could alternatively be received and distributed through the multi-channel sound source without the need for physical media such as a DVD.

A multi-channel sound source transmits different sounds to different speakers to create a sound effect in which the sound emitted from the speakers may appear to be in motion or all around a person in a room. The surround sound effects from the system may simulate an environment such that a listener may be unable, except for visual clues, to differentiate the simulated environment emanating from the surround sound system from that of an actual occurrence. These sounds may be stored as data on a DVD or CD, and accessed by the multi-channel sound source for playing from the plurality of speakers.

Many sound editing computer software programs have become commercially available, such as Deck 3.5 by Bias, Inc. (Petaluma, Calif.) for creating a surround-sound soundtrack. For example, a voice actor may read a script into a microphone that is connected to a computer. The actor's voice may be digitally recorded through the use of the software. The result is computer data visually represented on a computer screen by an audio waveform. The waveform may be a few sentences of digitally recorded voice audio, for example. Mixing surround sound may involve using the software to break or fade this waveform into separate portions of smaller waveforms and designating from which speaker the smaller waveforms should emanate.

For example, a waveform might be broken into three separate pieces of information. A programmer may program which speaker each piece of information emanates from. A common method of this type of programming is with a panner, a software device commonly known in the art which may be adjusted to program any number of speakers for audio output.

After breaking the waveform of dialogue into multiple pieces, a first panner may be used to direct one piece of the waveform to play out of a front left speaker while a second panner may be used to play a second piece of the waveform out of the front right speaker.

Another feature of a panner that may be used is an ability to incorporate a control point. The control point may be used to create fading effects. For example, the control point may be used to make one long audio clip fade from one speaker into another, creating a sound that appears to move about a room.

The splitting of waveforms for use in a surround sound system facilitates a programmer's ability to create an entire sequence of audio sounds and direct from which speaker or speakers the audio sounds should emit.

Various types of audio cues are previously recorded for use in a multi-channel speaker system such as a surround sound system. These audio cues may be stored on a device such as a digital video disc (DVD). When the DVD is played, such as on a conventional DVD player, which is, or is connected to, a multi-channel sound source and a plurality of speakers, a listener may play a game in accordance with an exemplary embodiment of the invention. The content of the audio cues stored on the DVD may be in story form. As the audio cues are played, the story unfolds in such a manner as to encourage physical interaction by the player.

Alternatively, the audio cues may be randomized. As is well known, CDs and DVDs may have a series of audio or audio and video tracks which permit a user to randomize song selection or scene selection with albums or movies. Similarly, the audio cues stored on a CD or DVD for use in the method of playing the game of the invention may likewise be randomized to add a level of variety to the game, such that the game need not always be played in the same way.

In an exemplary embodiment of the invention having a story format, a story may be about a day at the zoo where an animal escapes, for example. Although the nature of the underlying story is not critical, the story may preferably be of such a nature to appeal to young children, such as toddlers, to further encourage participation in playing the game.

A person, such as a child, may begin playing the game by listening to various sounds emitted from the surround sound system. The game may played by one or more persons. Accordingly, although references may be made to a single player, the described embodiments are not to be so limited and may additionally include multiple players.

Different audio cues may be emitted from different speakers according to how the data is programmed on the DVD. For example, a player may start in the middle of a room containing the surround sound system. The audio cues may include narration which introduces the story and describes what is happening. Further audio cues may elicit physical response from the player, such as directional audio cues which elicit a player changing position with respect to the speakers, or instructional audio cues which elicit changing posture, performing an act, and the like.

Alternatively, or in combination with the narration, the DVD may also contain video data which is sent by the DVD player via video signal to a video display device, such as a television or a computer monitor, which may provide further narrative, supportive information, or the like.

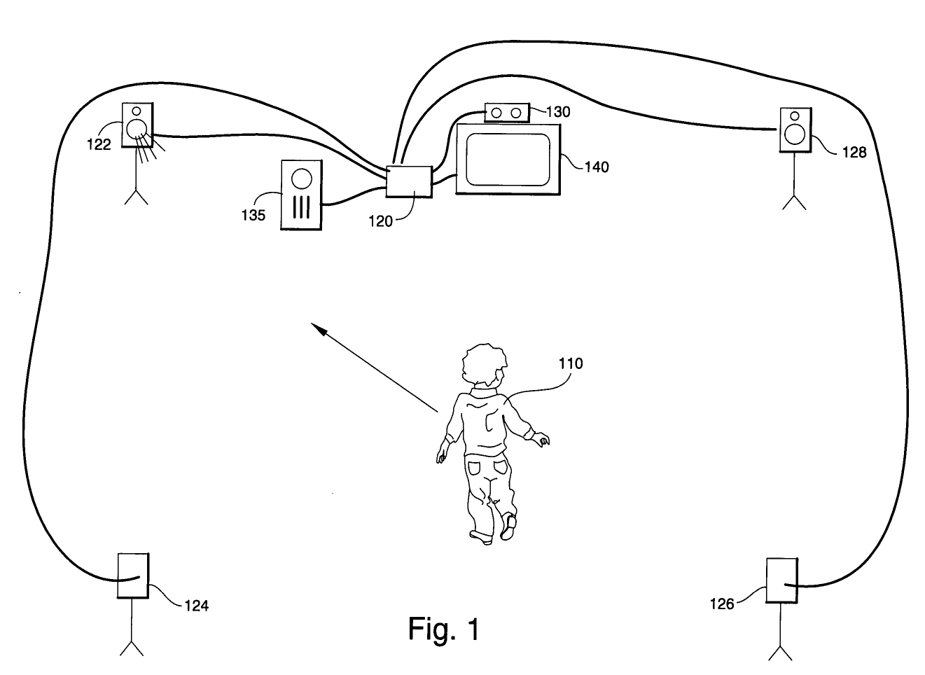

As the game begins, a player is urged to different locations within the room. For example, as shown in FIG. 1, a directional audio cue may urge a player to approach a certain speaker to share a secret with the player. As shown in FIG. 1, the first audio cue emanates from the front left speaker 122, to which the player participates by moving about the room in response. In this example, the player moves toward the front left speaker 122 in response to the directional audio cue urging the player to approach.

Once the player moves to the speaker in response to the first directional audio cue, a second directional audio cue may be emitted by that, or another speaker. It should be appreciated that the volume of the emitted directional audio cues may be programmed so that physical movement by a player to a particular speaker may be needed to hear a next directional audio cue, such that a non-player sitting in the middle of the room, for example, may not hear all of the audio cues a player may hear.

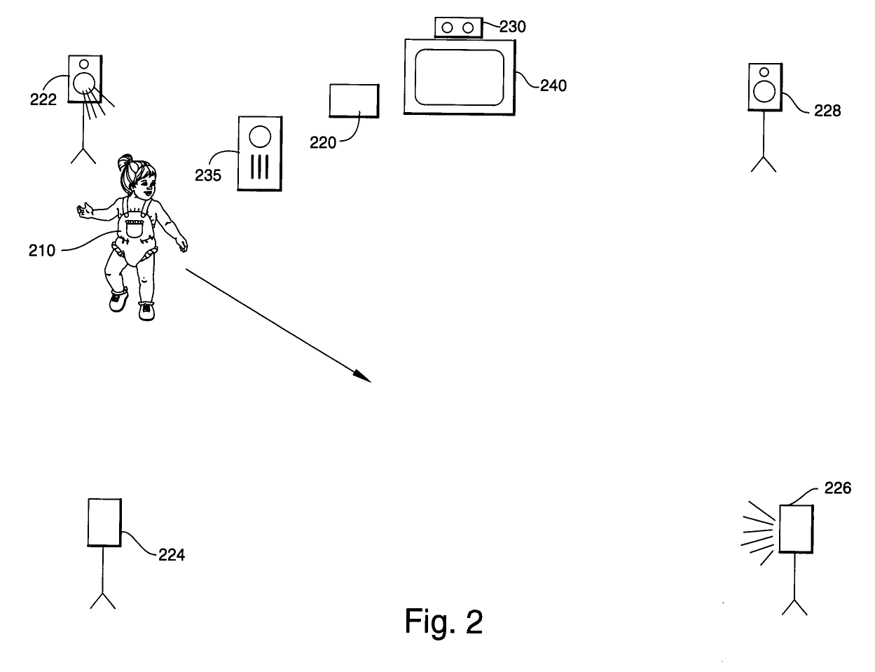

To continue the present example, a directional audio cue may be whispered by a narrator. The directional audio cue may whisper to a player that an elephant had escaped from its cage and the directional audio cue may further urge the player to run away from the speaker. The directional audio may still further urge a player to a second location to hide from the elephant, as shown in FIG. 2 in which a second directional audio cue urging a player toward a rear right speaker 226 from the front left speaker 222. As the player begins to move, additional directional audio cues may be emitted simultaneously or in quick succession from different speakers encouraging the player to run to different locations. For example, another speaker could emit a directional audio cue such as “it will be safe over here” followed by “no, over here” from another speaker. Alternatively, or in combination with these directional audio cues which provide direct cues to a player, other directional audio cues which provide indirect cues are possible, such as an angry elephant trumpet, for example, emitted from a speaker urging a player away from that speaker.

The game continues in similar fashion as players move to and from different locations in the room based on the directional audio cues emitted from the different speakers.

While the players are moving about the room in response to the directional audio cues, background audio cues may be emitted to create a surround sound effect of a simulated audio environment. In the zoo example described, while the players are moving about the room in response to the directional audio cues, background audio cues may also be emitting from a plurality of speakers with sounds such as people laughing and various animal sounds which may simulate the sounds one might hear at an actual zoo creating a simulated environment as the sound appears to be all around the player. In response to this environment, the player additionally acts out scenes corresponding to the simulated environment. For example, in a simulated zoo environment, the player may act out scenes corresponding with animals at the zoo, such as pretending to pet or herd animals which are heard all around the player. Other scenes may include the player pretending to buy balloons or eat ice cream, for example, or any other scenes which correspond to the simulated environment.

The background audio cues may also be used to suggest a more specific simulated environment, such as an imaginary cave where a player may be directed to hide from the elephant by a directional audio cue. Through the use of the background audio cues, the audio environment of a cave may be simulated by the sound of dripping water coming from different speakers or echoing voices. Further, the background audio cues may be presented in a manner to suggest a change in the distance between the audio cues and the player, such as the sound of a vehicle moving into the distance or coming close to the player, for example.

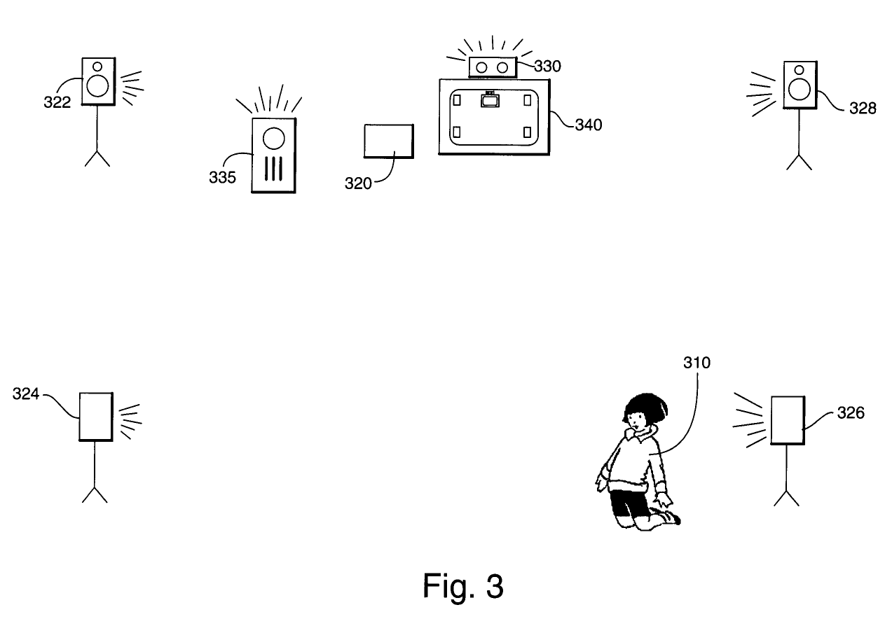

In another exemplary embodiment of the invention, a player may assume a posture or engage in a particular activity, either while stationary or while moving about the room in response to an instructional audio cue emitted from one or more of the speakers. For example, if the background audio cues suggest the cave is full of bats by producing a surround sound effect simulating a flock of bats screeching and flying around the room, an instructional audio cue may tell the players to duck, as shown in FIG. 3. Other examples of instructional audio cues may include urging a player to look in a certain direction or to jump over imaginary things such as puddles, for example. A player participates in the game by following the instructions to act out the scenes described by the audio cues and the surround sound environment.

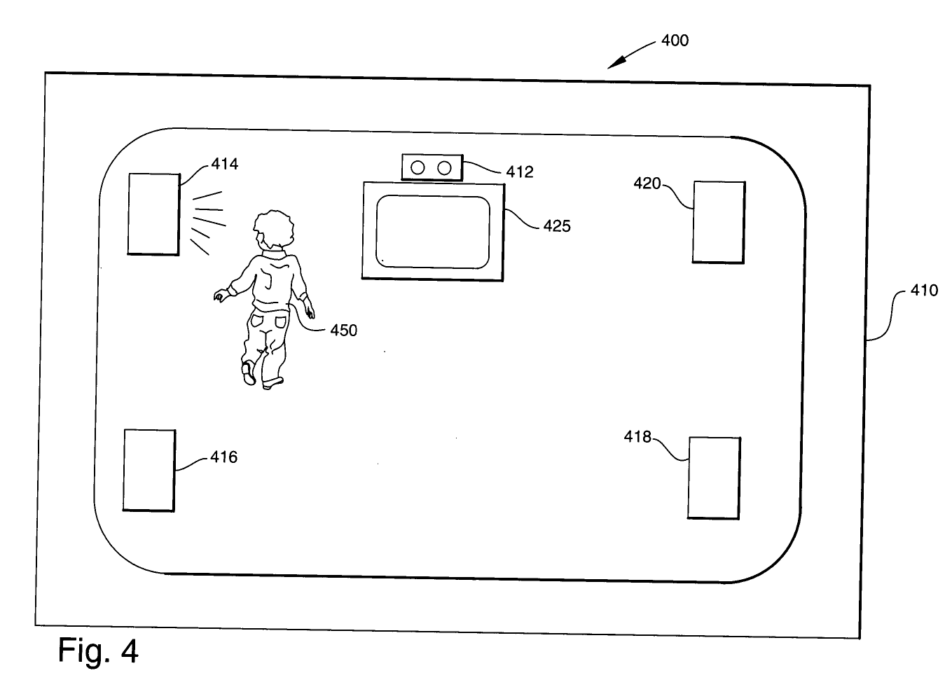

In another exemplary embodiment, visual cues may be simultaneously provided with the various types of audio cues to a display device such as a television screen or computer monitor. The visual cues may aid a player by visually displaying where the player should be located in the room as the game progresses. FIG. 4 shows a visual cue 400 displayed on a display screen 410. On the screen, icons representing the front center speaker 412, the left front speaker, 414, the left rear speaker 416, the right rear speaker 418, and the right front speaker 420, along with a display screen icon 425 are displayed. A player icon 450 is displayed on the screen and changes over the course of the game based on where a player should be located. For example, if the player was urged toward the front left speaker, icon 450 would move on the display screen to a location near the front left speaker icon 414 to assist a player to move to the correct location at the front left speaker.

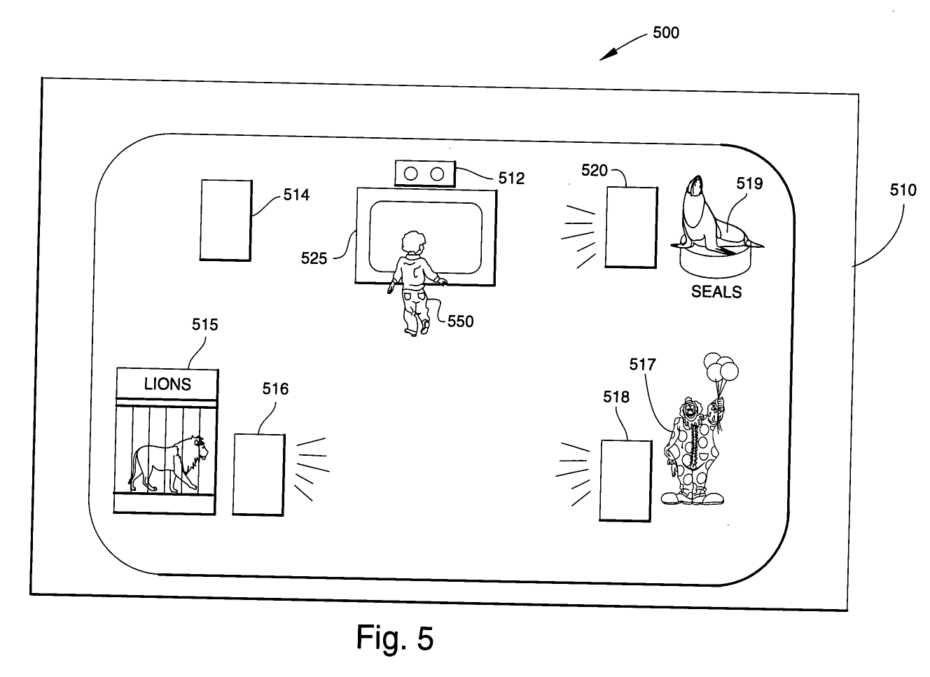

The visual cue may show only the player with respect to the speaker location as in FIG. 4, or it could additionally show locations of the purported source of replicated sounds. For example, as shown in FIG. 5, the visual cue 500 could show where a player, represented by a player icon 550 should be with respect to the speaker locations, as represented by speaker icons 512, 514, 516, 518, 520, but may additionally show a map of, for example, a zoo, in relation to the player. For example, if background audio cues simulate lion roars coming from one or more of the left speakers as visually represented by the left rear speaker icon 516, a lion cage may be visually displayed as an icon 515 on the display device to aid a player with realizing the simulated environment.

Alternatively, or in addition to the aid provided with respect to player location, a visual cue may aid a player by visually displaying a posture the player should assume. For example, if an instructional audio cue indicates that a player should duck, a visual cue showing a figure ducking may be displayed, as shown on the visual display device 340 in FIG. 3, corresponding to the instructional audio cue urging the player to duck.

Other visual cues may include a video or graphical representation to complement the surround sound environment by creating a visual environment to further aid a player in acting out scenes in accordance with the method of the invention. For example, when a player is acting out a scene inside a cave, the visual cue may show a small light representing a cave entrance or exit. Other examples of environmental visual cues may include a flickering fire or a star field to visually replicate any environment corresponding to any surround sound replicated environment.

Still another form of visual cue may be displayed in some embodiments of the invention. The display device may display visual cues in the form of text. A player may further participate in the game by reading the text from the visual cue to further act out the environments created by the game. By doing so, the player further participates in the game by engaging in a dialogue with the audio cues emitted from the speakers, which may promote social interaction.

Yet another exemplary embodiment of the invention further includes the use of props by the player. As the player moves about the room in response to the directional audio cues, the directional audio cues may direct the player to search for props, pre-placed in a particular location before the game begins based on instructions which may accompany the game. For example, in the zoo example, the player may be asked to search for keys to the escaped elephant's cage to help lock up the escaped elephant when it is captured. Directional audio cues may direct the player toward a location in the room which has a set of keys which was pre-placed in the room prior to beginning the game. The player uses the props to play the game by continuing to act out scenes corresponding to the props, as well as the background audio cues, directional audio cues and instructional audio cues.

The game ends when the story is over and the player is no longer directed to move about the room or respond to the audio cues created by the surround sound system.

The present invention is not to be limited in scope by the specific exemplary embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Accordingly, the claims set forth below should be construed in view of the full breath and spirit of the present invention as disclosed herein.

1. A method of play comprising:
receiving a first set of directional audio cues transmitted from a multi-channel sound source to at least one of a plurality of speakers positioned within a defined space, the directional audio cues directing a player to move from a first location to a second location within the defined space;
responding to the first set of directional audio cues by moving from the first location to the second location within the defined space corresponding to the first set of directional audio cues;
receiving at least a second set of directional audio cues at the second location in the defined space;
responding to at least the second set of directional audio cues by moving about the defined space from the second location to at least a third location corresponding to at least the second set of directional audio cues; and
acting out scenes which correspond to a surround-sound environment created by the multi-channel sound source simultaneously emitting different complementary background audio cues from each of the plurality of speakers.

2. The method of claim 1 further comprising watching visual cues displayed on a display device.

3. The method of claim 2 wherein the visual cues show a correct player location in the defined space.

4. The method of claim 2 wherein the visual cues depict an environment corresponding to the surround-sound environment.

5. The method of claim 2 wherein the visual cues show a correct player posture.

6. The method of claim 2 wherein the visual cues urge a player to verbally react.

7. The method of claim 2 wherein the directional audio cues, background audio cues, and visual cues are chronologically sequenced in story-form.

8. The method of claim 2 wherein the directional audio cues are randomized.

9. The method of claim 1 wherein the multi-channel sound source and the plurality of speakers are a surround sound system.

10. The method of claim 9 wherein the surround sound system is a 5.1 surround sound system.

11. The method of claim 10, wherein the speakers are positioned within the defined space.

12. A method for stimulating creative imagination in children comprising:
emitting a directional audio cue from a multi-channel sound source to one of a plurality of speakers positioned within a defined space to urge a child toward or from a first location in the defined space;
emitting at least a second directional audio cue from at least one of the plurality of speakers urging the child toward or from another location in the defined space;

13. The method of claim 12 further comprising displaying a visual cue from a display device to a display screen, the visual cue related to an audio cue.

14. The method of claim 12 further comprising simultaneously emitting different complementary sounds from each of the plurality of speakers to create a surround-sound environment.

15. The method of claim 12 further comprising emitting at least one instructional audio cue urging the child to perform a pre-defined act in response to the audio cue.

16. The method of claim 13 wherein the visual cue shows a correct location for the child to be positioned within the defined space.

17. The method of claim 13 wherein the visual cue provides a visual cue urging a child to verbally react to the visual cue.

18. The method of claim 13 wherein the visual cue provides a visual cue urging a child to assume a posture.

19. The method of claim 13 wherein the visual cue depicts an environment.

20. The method of claim 12 further comprising emitting instructional audio cues urging a player utilize at least one prop positioned in the room.

21. A system for stimulating creative imagination in children comprising:
a multi-channel sound source;
a plurality of speakers connected to receive audio signals from the multi-channel sound source;
a video display source;
a display device connected to receive video signals from a video display source; and
a device containing audio data capable of distribution through the multi-channel sound source to the plurality of speakers and containing video data capable of distribution to the display device, which audio data includes directional audio cues, background audio cues, and instructional audio cues.

22. The system of claim 21 wherein the multi-channel sound source and the plurality of speakers are a surround sound system.

23. The system of claim 22 wherein the surround sound system is a 5.1 surround sound system.

24. A method of play comprising:
receiving a first set of directional audio cues emitting from one of a plurality of speakers connected to a 5.1 surround sound system directing a player to move from a first location to a second location with a defined space;
responding to the first of directional audio cues by moving from the first location to the second location;
receiving at least a second set of directional audio cues at the second location from one of a plurality of the speakers;
responding to least the second set of directional audio cues at the second location by moving to at least a third location corresponding to at least the second set of audio cues;
acting out scenes which correspond to a surround-sound environment created by simultaneously emitting complementary sounds from at least two of the plurality of speakers and which further correspond to at least one set of instructional audio cues emitted from at least one of the plurality of speakers;
watching visual cues displayed on a video display device to ascertain a correct player location in the defined space.
